(19) United States
(12) Patent Application Publication
(10) Pub. No.: US 2016/0144272 A1
(43) Pub. Date: May 26, 2016

(54) Greeting Card with Interactive Maze Game

(71) Applicant: American Greetings Corporation, Cleveland, OH (US)

(72) Inventor: Melissa Flesher, Avon, OH (US)

(21) Appl. No.: 14/950,080

(22) Filed: Nov. 24, 2015

Related U.S. Application Data
(60) Provisional application No. 62/084,141, filed on Nov. 25, 2014.

(51) Int. Cl. A63F 9/00; B42D 15/02

(52) U.S. Cl. CPC A63F 9/001; A63F 9/0078; B42D 15/022; A63F 2009/0049

(57) ABSTRACT

An integral greeting card and game featuring a plastic moulded maze with a ball contained therein. A press button controls activation of audio wherein the user races against the clock to move the ball to the end or center of the maze before the audio clip ends.

### RELATED APPLICATIONS

This application is a non-provisional of and claims priority to U.S. Provisional Patent Application No. 62,084,141, filed on Nov. 25, 2015, a copy of which is incorporated herein by reference in its entirety.

### FIELD OF THE INVENTION

The present invention is in the field of social expression products. More specifically, the invention is directed to an interactive greeting card having a beat-the-clock maze game integral therewith.

### SUMMARY OF THE INVENTION

The present invention includes a greeting card/game combination. A plastic moulded maze is integral with a greeting card. A small ball is contained within the maze. A press button controls activation of audio wherein the user races against the clock to move the ball to the end or center of the maze before the audio clip ends.

### DESCRIPTION OF THE DRAWINGS

FIG. 1 is a perspective view of the GREETING CARD of the present invention.

FIG. 2 is a front view of the GREETING CARD of FIG. 1, with tear-away lower portion.

FIG. 3 is a top view of the GREETING CARD of FIG. 1, from the direction of arrows 3-3.

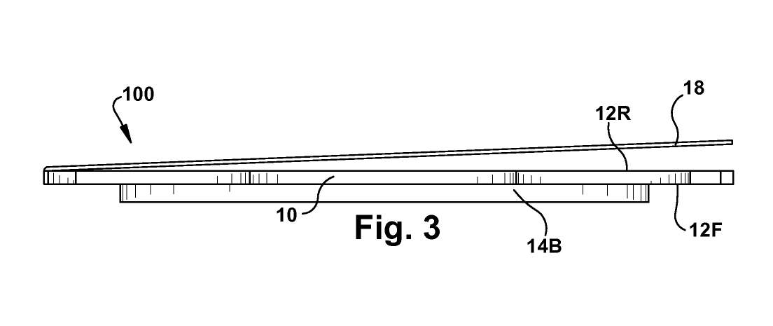

### DETAILED DESCRIPTION OF PREFERRED AND ALTERNATE EMBODIMENTS

The greeting card of the present disclosure and related inventions includes a greeting card having an interactive game which is integral therewith. The greeting card additionally contains audio capabilities which relates to the game such that the audio clip serves as a game timer wherein the user must solve the maze puzzle before the audio clip comes to an end.

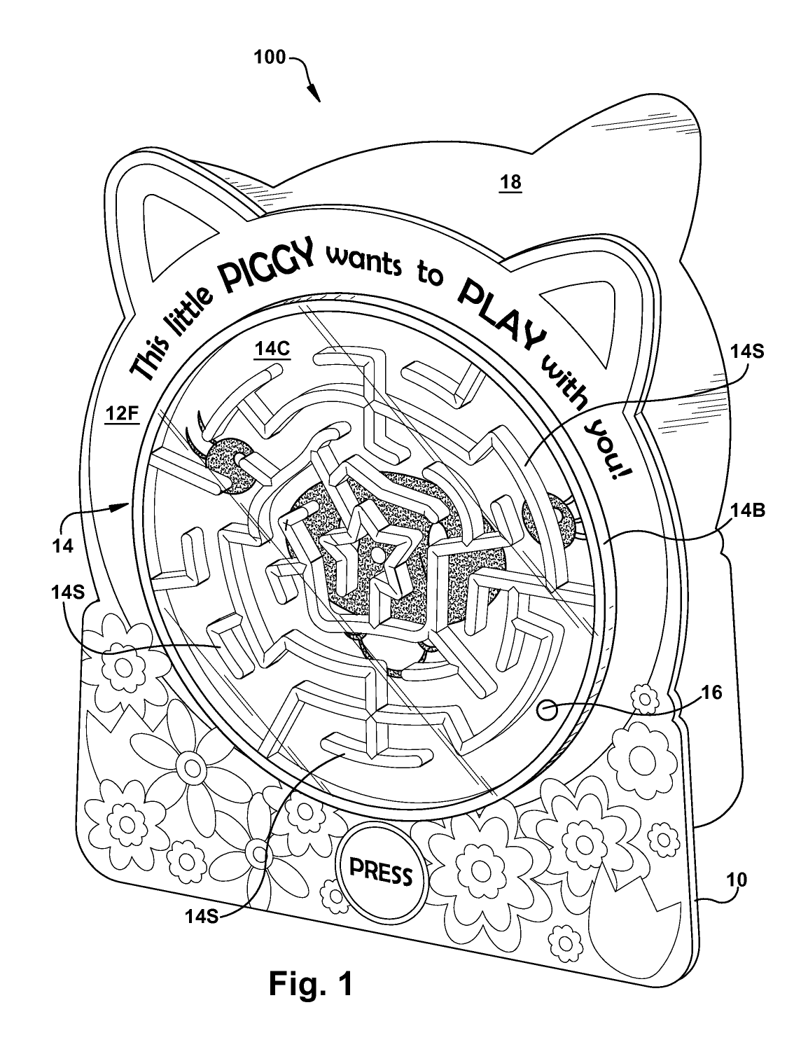

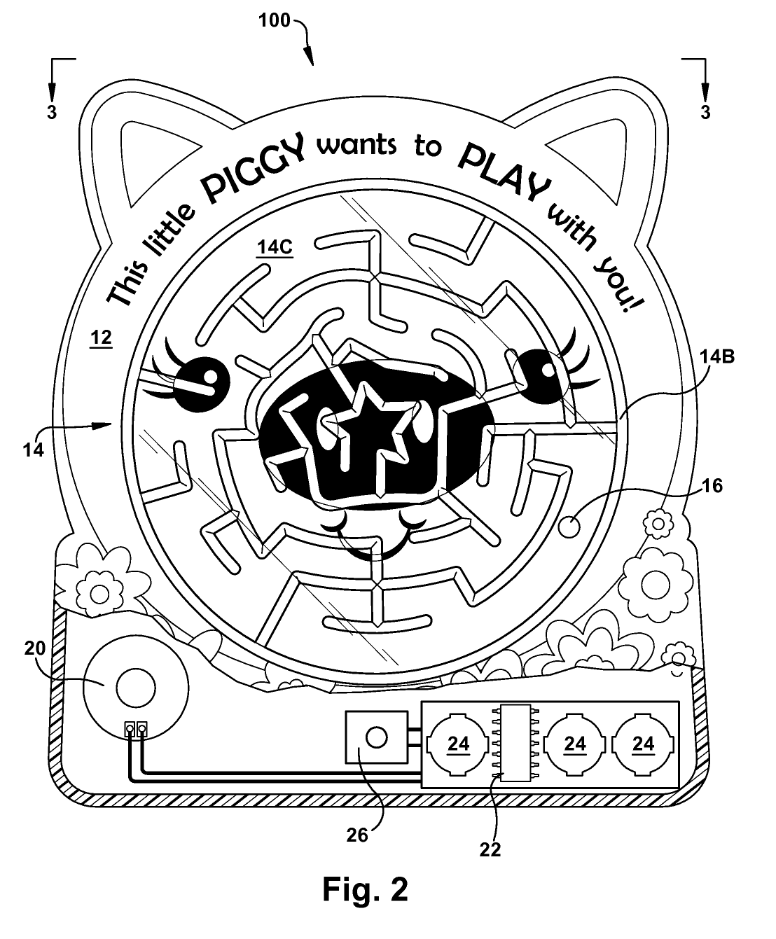

The greeting card 100 includes a foam construct 10 having a front surface, a rear surface and a perimeter surface therebetween. A paper or paperboard sheet material 12 may cover the rear surface and a portion of the front surface of the greeting card 100. The foam construct 10 may be shaped in a variety of configurations and the sheet material 12 can be shaped in the same form as the foam construct 10. The sheet material 12 may contain printing thereon containing text, photos, drawings, etc. and may contain additional small embellishments. The foam construct 10 contains a large opening thereon into which a plastic moulded maze game 14 is inserted. The maze game 14 includes a base 14B containing various segments arranged in a maze or pattern. A small ball 16 is inserted into the maze 14 and a transparent plastic cover 14C is attached over the maze 14 to enclose the ball 16 therein, creating a closed structure. This structure 14 is inserted into the opening in the foam construct 10 to become integral with the greeting card 100. The maze game 14 is visible from the front of the greeting card 100, as shown in FIGS. 1 and 2. A sentiment panel 18 is attached to the edge of the sheet material which is attached to the rear surface of the foam construct 10. The combined front sheet material 12F and maze game 14 represent the front cover of the greeting card 100. The rear sheet material 12R serves as the inside left panel of the greeting card 100. The front surface of the sentiment panel 18 serves as the inside right panel of the greeting card 100 and the opposing rear surface of the sentiment panel 18 serves as the rear cover of the greeting card 100. The greeting card 100 is opened by pivoting the sentiment panel 18 away from the foam construct 10.

As mentioned above, the maze game 14 contains a base portion 14B and a cover portion 14C. The base potion 14B contains a flat floor surface and a side or perimeter surface that extends around the edges of the flat surface in a perpendicular manner, creating an interior of the base structure 14B. Within the interior are various interconnected segments 14S which are arranged into a maze configuration wherein various routes contain a dead end while various other routes contain an open path which leads to the center of the maze. The interconnected segments 14S which make up the various paths of the maze are perpendicular to the flat floor surface of the base portion 14B and are similar in height to the perimeter surface of the base portion. The cover portion 14C of the maze game 14 contains a transparent planar sheet with a perpendicular border which extends around the edges thereof and which fit over the perimeter surface of the base portion 14B and are permanently attached thereto. Prior to attaching the base 14B and cover portion 14C, a small ball 16 is inserted into the base portion 14B such that when the cover portion 14C is attached thereto, the ball 16 is trapped between the base 14B and cover 14C portion, creating the maze game 14. The entire maze game 14 is inserted into an opening on a front surface of the foam construct 10 and permanently attached thereto. In a preferred embodiment, both the base 14B and cover 14C portion of the maze 14 are transparent and preferably plastic, although other materials may be used. The base portion 14B of the maze game may alternatively be non-transparent and contain printing thereon. However, in the preferred embodiment, the entire maze game 14, including the base 14B and cover 14C portions are transparent. The inside surface of the sheet material which covers the rear surface of the foam construct may contain printing thereon which is visible through the transparent base 14B and cover 14C portions of the maze game 14. Also, in the embodiment shown in the figures, the maze game 14 has a circular shape which fits into a circular opening in the foam construct 10. However, the maze 14 may be made into any conceivable shape.

Various electronic components, including a sound module, are contained within a cavity or opening in the foam construct 10. The sound module may include any and all components necessary to store and produce or emit sound through a speaker 20. Some of the internal electronic components may include, but are not limited to: a circuit board 22; an integrated circuit chip; a power source 24; a speaker 20; a memory device for storing at least one audio clip; and a switch 26. The electronic components of the greeting card described herein are considered to be readily understood and appreciated by one of ordinary skill in the art and are therefore not discussed in detail herein. In addition to audio capabilities, the greeting may additionally contain further electronic components which may facilitate additional electronic features such as one or more lights and a motor for effecting movement of a portion of the greeting card. In a preferred embodiment, the greeting card 100 contains a push button switch 26 which is operative to initiate audio playback. The push button switch 26 may be accessed through the front cover of the greeting card 100, beneath the sheet material 12 covering the front surface of the foam construct 10 and proximate to the maze game 14. Printing on the front sheet material 12 may direct the user to “push” or “press” on that particular area to begin audio playback, as shown in FIG. 1.

In operation, the greeting card 100 of the present invention is intended to be a beat the clock game wherein the user starts the game by pushing the press button 26 and initiating the audio. While the audio is playing, the user must try to move the ball 16 along the various paths 14S of the maze game 14 to reach the center of the maze (shown in the figures as a partially shaped star) before the audio ends. The user moves the ball 16 through the paths 14S of the maze by holding the greeting card 100 and moving it in various directions in order to push the ball 16 along the paths 14S of the maze. Some of the maze paths 14S are dead-ends and require the user to back out of the current path and take a different path to reach the center of the maze. The user wins the game if he/she can move the ball 16 into the center of the maze before the audio ends. The center of the maze may be indicated by a particular shape such as a star or bulls eye. The user can also play the maze game without initiating the audio by simply moving the greeting card 100 in various directions to push the ball 16 along the various paths of the maze. The audio may play for a certain pre-determined period of time before ending, such as 10 seconds, 15 seconds, 20 seconds, greater than 20 sections, less than 20 seconds, or any other suitable time period.

As mentioned above, the foam construct 10 may take any shape and the sheet material 12 may contain various printing thereon which complement or follow a theme of the greeting card 100. For example, as shown in the figures, the foam construct 10 is vaguely shaped like a pig's head. The inside surface of the sheet material 12 which covers the back of the foam construct contains printing of a pig's face which shows through the transparent maze 14 on the front of the greeting card 100. The front sheet material 12 and sentiment panel 18 may be decorated in a complementary manner to carry out the theme of the greeting card 100.

While the greeting card of the present invention has been described herein and shown in the figures as being made of specific materials and having various components taking on specific shapes or sizes, other shapes, sizes and materials have been contemplated and are considered to be within the scope of the present invention. While the switch has been described as being a push button switch, other types of switches may be used such as, but not limited to: touch sensitive switch, light sensitive switch; contact switch, slide switch, or any other type of switch known to one having skill in the art. Also, while the maze has been described as being on the front cover of the greeting card, it may alternately be located on an inside surface of a greeting card. Other materials besides plastic and foam can be used to construct the greeting card as well.

The foregoing embodiments of the present invention have been presented for the purposes of illustration and description. These descriptions and embodiments are not intended to be exhaustive or to limit the invention to the precise form disclosed, and obviously many modifications and variations are possible in light of the above disclosure. The embodiments were chosen and described in order to best explain the principle of the invention and its practical applications to thereby enable others skilled in the art to best utilize the invention in its various embodiments and with various modifications as are suited to the particular use contemplated. It is intended that the invention be defined by the following claims.

1. An interactive greeting card comprising:
a multi-panel greeting card body;
a maze game having a base portion with various interconnected segments creating various pathways, at least one pathway leading to a center of the maze, and a cover portion which is placed over the base portion to create a closed cavity;
a ball contained within the closed cavity of the maze game which is operative to move between the various pathways;
a sound module which is operative to store and replay at least one audio clip;
a switch which controls activation of the sound module and replay of the at least one audio clip.

2. The interactive greeting card of claim 1, wherein the maze is inset into a foam construct.

3. The interactive greeting card of claim 2, wherein the foam construct is at least partially covered by a planar sheet material.

4. The interactive greeting card of claim 1, wherein the maze game is made of molded plastic.

5. The interactive greeting card of claim 1, wherein the maze game is made of transparent material.

6. The interactive greeting card of claim 1, wherein the at least one audio clip plays for a predetermined period of time.

7. The interactive greeting card of claim 1, wherein the object of the maze game is for a user to move the ball to a center of the maze before the at least one audio clip has finished playing.

8. An interactive greeting card game comprising:
a greeting card body;
a maze attached to the greeting card body, the maze comprising a plurality of segments which make up a plurality of pathways from an outer area of the maze to a center of the maze, and a transparent cover which creates a closed structure;
a ball which is operative to move through the plurality of pathways of the maze;
a sound module which is operative to store and playback at least one audio file;
a switch which is operative to activate the sound module.

9. The interactive greeting card game of claim 8, wherein the maze is attached to the front face of the greeting card body;

10. The interactive greeting card game of claim 8, wherein the object of the game is to get the ball to the center of the maze before the audio file plays to completion.

11. The interactive greeting card game of claim 8, wherein a portion of the greeting card is made of foam.

12. The interactive greeting card game of claim 8, wherein the maze is surrounded by the foam.

13. The interactive greeting card game of claim 8, wherein the switch is a push button switch.

14. The interactive greeting card game of claim 13, wherein the switch is accessed through a front face of the greeting card.

15. The interactive greeting card of claim 8, wherein the maze is made of transparent molded plastic.

16. An interactive greeting card comprising:
a greeting card body;
a game attached to the greeting card body, the game comprising a maze and a ball enclosed within the maze;
a sound module operative to store and replay at least one audio file;
a switch which is operative to initiate replay of the at least one audio file;
wherein a user can move the ball through the maze by tilting the greeting card in different directions.

17. The interactive greeting card of claim 16, wherein the object of the game is to move the ball to a center of the maze.

18. The interactive greeting card of claim 17, wherein the center of the maze is indicated by having a shape which is different than the rest of the maze.

19. The interactive greeting card of claim 16, wherein a portion of the greeting card body is made of foam.

20. The interactive greeting card of claim 16, wherein the switch is a press-button switch.
